(19) United States
(12) Patent Application Publication
(10) Pub. No.: US 2026/0120107 A1
(43) Pub. Date: Apr. 30, 2026

(54) Electronic Devices, Methods, and Corresponding Systems for Precluding User Interaction Events in an Interactive Computing Environment

(71) Applicant: Motorola Mobility LLC, Chicago, IL (US)

(72) Inventors: Vijayprakash Idlur, Bangalore (IN); Prasad AG, Bangalore (IN); Krishnan Raghavan, Bangalore (IN)

(21) Appl. No.: 18/932,447

(22) Filed: Oct. 30, 2024

(51) Int. Cl. G06Q 20/40; G06Q 30/0601

(52) U.S. Cl. CPC G06Q 20/4016; G06Q 30/0609

(57) ABSTRACT

An electronic device and method for managing user interactions in an electronic shopping environment. The system determines a fraudulent return propensity score based on shopping cart interaction events across multiple sessions. When the score exceeds a predefined threshold, the system precludes additional user interactions, such as shopping cart completion or product returns. The method involves analyzing factors like delivery address, location, and time taken for interactions. The device includes processors and memory to execute these functions, enhancing fraud detection and maintaining the integrity of return policies. The system provides prompts to users when certain interactions are restricted.

### BACKGROUND

### Technical Field

This disclosure relates generally to electronic devices, and more particularly to electronic devices having user interfaces.

### Background Art

Portable electronic devices, such as smartphones and tablet computers, are now the primary electronic tools with which people communicate, engage in commerce, maintain calendars and itineraries, monitor health, capture images and video, and surf the Internet. In many instances, a person is more likely to carry a smartphone than a watch or wallet. Indeed, with the advent of personal finance, banking, and shopping applications many people can transact personal business solely using a smartphone and without the need for cash or a physical credit card. When used in conjunction with e-commerce sites, such devices make it incredibly simple to purchase goods and services with just a click or two.

At the same time, fraudulent returns remain a significant problem in e-commerce, with dishonest customers exploiting return policies to return used or mismatched items for refunds or exchanges, resulting in financial losses for retailers. It would be advantageous to have improved electronic devices, methods, and corresponding systems that alleviate this problem.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one or more method steps in accordance with one or more embodiments of the disclosure.

FIG. 2 illustrates one explanatory electronic device in accordance with one or more embodiments of the disclosure.

FIG. 3 illustrates one explanatory networked electronic device in accordance with one or more embodiments of the disclosure.

FIG. 4 illustrates one explanatory method in accordance with one or more embodiments of the disclosure.

FIG. 5 illustrates another explanatory method in accordance with one or more embodiments of the disclosure.

FIG. 6 illustrates yet another explanatory method in accordance with one or more embodiments of the disclosure.

FIG. 7 illustrates one explanatory electronic device in accordance with one or more embodiments of the disclosure.

FIG. 8 illustrates another explanatory electronic device in accordance with one or more embodiments of the disclosure.

FIG. 9 illustrates still another explanatory electronic device in accordance with one or more embodiments of the disclosure.

FIG. 10 illustrates one explanatory system in accordance with one or more embodiments of the disclosure.

FIG. 11 illustrates various embodiments of the disclosure.

FIG. 12 illustrates a prior art situation that can lead to fraudulent returns.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to, in response to initiation of a plurality of interactive sessions in an electronic shopping interactive computing environment operating on one or more processors of the electronic device, determining, by the one or more processors, a fraudulent return propensity score as a function of a plurality of shopping cart interaction events occurring in the plurality of interactive sessions in the electronic shopping interactive computing environment and, when the fraudulent return propensity score exceeds a predefined threshold, precluding one or more additional user interaction events from occurring in each interactive session of the plurality of interactive sessions in the electronic shopping interactive computing environment. Any process descriptions or blocks in flow charts should be understood as representing modules, segments, or portions of code which include one or more executable instructions for implementing specific logical functions or steps in the process.

Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

It will be appreciated that embodiments of the disclosure described herein may be comprised of one or more conventional processors and unique stored program instructions that control the one or more processors to implement, in conjunction with certain non-processor circuits, some, most, or all of the functions of, in response to one or more processors of an electronic device detecting a plurality of shopping cart interaction events occurring in a plurality of interactive shopping sessions occurring in an electronic shopping application operating on the one or more processors, determining a fraudulent return propensity score as a function of a product category and a location area associated with each shopping cart interaction event being common across the each shopping cart interaction event of the plurality of shopping cart interaction events and, when the fraudulent return propensity score exceeds a predefined threshold, precluding one or both of the plurality of shopping cart user interaction events and/or a plurality of product return user interaction events corresponding to the plurality of product return user interaction events from occurring in the electronic shopping application as described herein. The non-processor circuits may include, but are not limited to, a radio receiver, a radio transmitter, signal drivers, clock circuits, power source circuits, and user input devices.

As such, these functions may be interpreted as steps of a method to perform operating, by one or more processors of the electronic device, an electronic shopping application and collating, by the one or more processors, a plurality of orders of products having a common category and originating from a common geographic area determining to determine a fraudulent return propensity score when the plurality of orders are compared to a historical set of orders of other products having a plurality of categories. In one or more embodiments, the method comprises presenting, by the one or more processors, on a user interface of remote electronic devices responsible for the plurality of orders, in response to the fraudulent return propensity score exceeding a predefined threshold, a prompt.

Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent.

The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

Fraudulent returns present a persistent challenge in the e-commerce sector, where customers exploit return policies to return used or mismatched items for refunds or exchanges. This behavior results in financial losses for retailers, impacting their profitability and operational efficiency. The issue arises from the ease with which customers can purchase and return items, often without sufficient scrutiny or verification, leading to misuse of return policies.

Illustrating by example, embodiments of the disclosure contemplate that the consistent purchase of identical items within a localized community can suggest a coordinated scheme potentially involving fraudulent returns. When numerous users from a confined area buy the exact same items, such as dresses or specific performance props, this can signal a coordinated effort rather than individual consumer preferences. This pattern of buying and subsequent return of indistinguishable items hints at a misuse of e-commerce systems, where these purchases are seemingly made for temporary use with the intention to return them afterward.

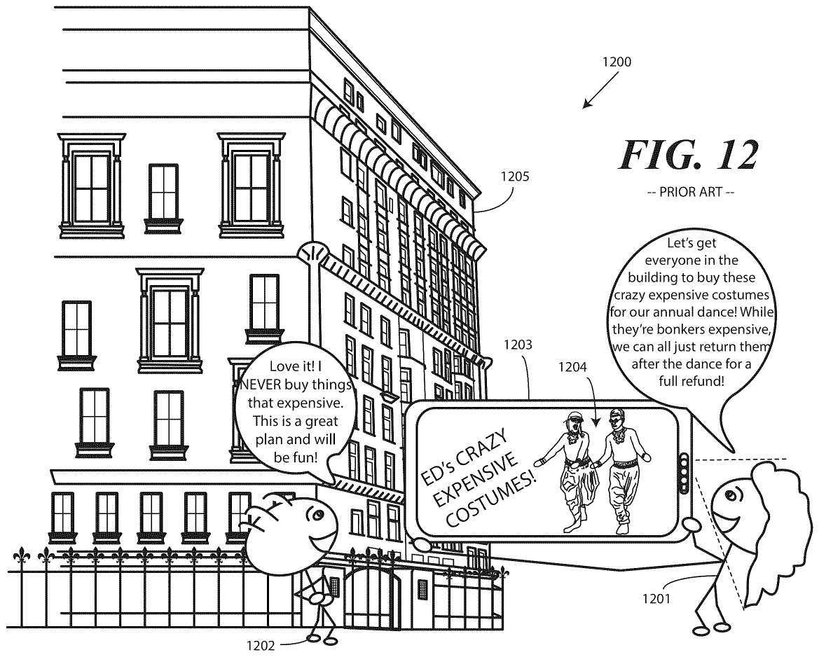

To illustrate just one such example, turn now to FIG. 12. In a real-life scenario, residents 1201,1202 of a community 1205 coordinate to purchase identical items, such as costumes for a festival or event. Indeed, FIG. 12 shows a scenario 1200 involving residents 1201,1202 within a community 1205 who coordinate to purchase identical items. In this illustrative example, the residents 1201,1202 coordinate to purchase “crazy expensive” costumes 1204 using an electronic device 1203 and a shopping application for the annual condominium hoedown.

In this illustrative example, resident 1201 engages in a persuasive dialogue with resident 1202, emphasizing the quality of costumes 1204 available from Ed's “Crazy Expensive” Costumes. Resident 1201 highlights that these costumes, although costly, have gained recognition for their use in prominent Broadway productions. The discussion includes references to fictitious shows such as “The Phantom's Masquerade” and “Starlight Dreams,” where renowned performers have praised the craftsmanship and attention to detail of Ed's creations.

Resident 1201 elaborates on the reasons behind the high price of Ed's costumes, attributing the high price to the use of premium materials and the meticulous design process. The conversation underscores the value of investing in such costumes, as they offer a blend of durability and aesthetic appeal, making them a worthwhile choice for any significant event. By sharing these insights, resident 1201 aims to convince resident 1202 of the benefits of purchasing from Ed's “Crazy Expensive” Costumes, despite the initial expense

Sadly, resident 1201 has no intent in “investing” in new costumes 1204 from Ed's “Crazy Expensive” Costumes. Instead, she is cooking up a scheme where the residents of the community 1205 can avail themselves of the benefits of Ed's “Crazy Expensive” Costumes by taking advantage of Ed's “Crazy Generous” return policy. Indeed, resident 1201 is convincing resident 1202 that the residents of the community that they should all collectively order new costumes 1204 for the annual condominium hoedown and then return them the next day for a full refund.

As shown in FIG. 12, resident 1201 orchestrates a plan to exploit Ed's “Crazy Generous” return policy by persuading the community 1205 to order costumes 1204 for the annual condominium hoedown. Resident 1201, lacking genuine intent to invest in these costumes 1204, aims to return them the next day for a full refund. This scheme involves convincing resident 1202 and others to participate, leveraging the return policy to enjoy the costumes 1204 without financial commitment.

Resident 1201 interacts with the electronic device 1203, which displays information about purchasing costumes. The electronic device 1203 facilitates coordination among residents for acquiring items from a specific vendor.

Resident 1202 participates in the purchasing process, engaging in discussions about the items displayed on the electronic device 1203. This interaction highlights the collaborative effort among community members.

The display on the electronic device 1203 shows promotional content related to the costumes, enticing residents to make purchases. The display serves as a visual tool for marketing and decision-making.

The community area 1205 represents the physical location where residents 1201 and 1202 reside. This area is central to the coordination of purchasing activities, emphasizing the localized nature of the transactions.

FIG. 12 thus illustrates a scenario involving residents 1201,1202 within a community 1205 who coordinate to purchase identical items, such as costumes 1204 for a festival or event. This coordination suggests a potential scheme involving fraudulent returns.

In this example, residents 1201 and 1202 of community 1205 engage in purchasing identical items for temporary use. After the event, they plan to initiate returns, citing generic reasons. The e-commerce platform, programmed with Ed's “Crazy Generous” return policy, processes these returns without recognizing the coordinated effort.

As one can imagine, this behavior poses significant challenges for Ed, as the return of used costumes 1204 results in financial losses and inventory disruptions. The repeated cycle of purchasing and returning items strains Ed's operational resources, impacting profitability and the ability to maintain a fair pricing structure. The lack of a robust system to detect and prevent such coordinated fraudulent activities leaves Ed vulnerable to ongoing exploitation.

Ed desperately desires a solution to address this pressing issue, ensuring the integrity of return policies and safeguarding business sustainability. At the same time, Ed does not want to cancel his “Crazy Generous” return policy, as it preserves the viability of Ed's business and maintains a fair shopping environment for genuine customers.

Current solutions to address fraudulent returns include tracking return patterns, identifying suspicious behavior, and employing fraud detection tools. Retailers often implement customer identity verification, restocking fees, and limited return windows. These measures aim to deter fraudulent activity by making the return process more stringent. However, these strategies can also inconvenience genuine customers and may not fully prevent coordinated fraudulent activities.

Advantageously, embodiments of the disclosure address the problem of fraudulent returns by analyzing multiple similar purchases from and to the same locality. In one or more embodiments, this approach involves recording specific data points such as the current locality, delivery address, and products in the cart. By collating this information, the embodiments of the disclosure identify patterns indicative of potential fraud, such as repeated purchases of similar items within a localized area. In one or more embodiments, a method calculates a fraud propensity score based on these patterns, allowing for preventive measures to be taken when the score exceeds a predefined threshold. This proactive approach aims to reduce fraudulent returns while maintaining a fair shopping environment for honest customers.

During fraudulent activities, items are used temporarily and subsequently returned, exploiting return policies. The method records specific data points, including the current locality, delivery address, and products in the cart, to identify such patterns.

For instance, in a community dance event, neighbors purchase identical dress materials and props online. After the event, they initiate returns, citing generic reasons. The e-commerce platform processes these returns without recognizing the coordinated effort. By collating information on similar purchases and returns, the method calculates a fraud propensity score. When this score exceeds a predefined threshold, preventive measures are implemented, such as converting the return policy to an exchange-only policy or blocking further purchases.

This approach aims to reduce fraudulent returns by identifying and addressing coordinated purchasing patterns. The approach preserves the integrity of return policies and maintains a fair shopping environment for genuine customers, while minimizing financial losses for retailers.

In the situation depicted in FIG. 12, the recurrence of these purchases for a specific purpose or event, followed by their swift return, deviates from regular consumer behavior. Such activities challenge the integrity of return policies and can mislead retailers, causing financial strain due to increased logistics and operational costs associated with handling these repetitive returns. Identifying and addressing this pattern preserves fairness and trust within e-commerce platforms, as this pattern impacts inventory management, strains logistical processes, and potentially influences return policies for customers

Advantageously, embodiments of the disclosure implement measures to identify patterns of coordinated purchases and returns can help mitigate these challenges. In one or more embodiments, a method records specific data points, including the current locality, delivery address, and products in the cart, to identify such patterns. By analyzing these data points, embodiments of the disclosure are able to calculate a fraud propensity score. When this score exceeds a predefined threshold, preventive measures are implemented, such as converting the return policy to an exchange-only policy or blocking further purchases. Embodiments of the disclosure aim to reduce fraudulent returns by identifying and addressing these purchasing patterns, preserving the integrity of return policies, and maintaining a fair shopping environment for genuine customers.

In one or more embodiments, a method implemented in an electronic device involves initiating multiple interactive sessions within an electronic shopping interactive computing environment. In one or more embodiments, the method includes determining a fraudulent return propensity score by analyzing various shopping cart interaction events that occur during these sessions. In one or more embodiments, the electronic device's processors perform this analysis to assess the likelihood of fraudulent returns based on the interaction patterns observed.

When the fraudulent return propensity score surpasses a predefined threshold, in one or more embodiments the method precludes additional user interaction events from taking place in each interactive session. This preclusion aims to prevent further actions that could lead to fraudulent returns, thereby safeguarding the integrity of the shopping environment. The method leverages the computing capabilities of the electronic device to monitor and control user interactions, ensuring that potentially fraudulent activities are identified and mitigated effectively.

Advantageously, embodiments of the disclosure enable the determination of a fraudulent return propensity score by analyzing a plurality of shopping cart interaction events across multiple interactive sessions. This approach allows for the identification of patterns indicative of potential fraud, such as repeated purchases and returns within a localized area, which are not easily detectable through conventional methods.

By precluding additional user interaction events when the fraudulent return propensity score exceeds a predefined threshold, embodiments of the disclosure effectively prevent further actions that could lead to fraudulent returns. This proactive measure helps maintain the integrity of the shopping environment and reduces financial losses for retailers by mitigating the impact of coordinated fraudulent activities.

The integration of this method into electronic devices enhances their functionality by leveraging computing capabilities to monitor and control user interactions in real-time. This ensures that potentially fraudulent activities are identified and addressed promptly, improving the overall security and reliability of e-commerce platforms.

In one or more embodiments, a method is implemented in an electronic device to address potential return fraud by analyzing purchase patterns. The method records specific data points, including the current locality of the user, the delivery address of the order, and the products in the cart. This information is used to identify patterns of similar purchases from the same locality, which may indicate coordinated efforts to exploit return policies. The method calculates a fraud propensity score based on these patterns, considering factors such as the time spent adding products to the cart and any previous return episodes by similar users.

When the fraud propensity score exceeds a predefined threshold, the method implements preventive measures. These measures may include converting the return policy to an exchange-only policy, blocking the new order from being made, or preventing access to the online shopping application. By leveraging the computing capabilities of the electronic device, the method aims to reduce fraudulent returns, preserving the integrity of return policies and maintaining a fair shopping environment for genuine customers.

In one or more embodiments, an electronic device comprises a memory and one or more processors operable with the memory. In one or more embodiments, the processors detect a plurality of shopping cart interaction events occurring in multiple interactive shopping sessions within an electronic shopping application. In one or more embodiments, the processors determine a fraudulent return propensity score based on a function of a product category and a location area associated with each shopping cart interaction event, ensuring that these elements are common across all events in the plurality of shopping cart interaction events.

In one or more embodiments, when the fraudulent return propensity score exceeds a predefined threshold, the processors preclude one or both of the plurality of shopping cart user interaction events and a plurality of product return user interaction events from occurring in the electronic shopping application. This mechanism aims to prevent further actions that could lead to fraudulent returns, thereby maintaining the integrity of the shopping environment and reducing potential financial losses for retailers.

Advantageously, this arrangement allows the device to identify patterns of potential fraud by analyzing commonalities in product categories and geographic locations across multiple shopping cart interactions. By leveraging this data, the device can effectively detect coordinated purchasing behaviors that may indicate fraudulent return schemes.

When the fraudulent return propensity score exceeds a predefined threshold, the processors preclude one or both of the shopping cart user interaction events and product return user interaction events from occurring. This proactive measure prevents further actions that could lead to fraudulent returns, thereby maintaining the integrity of the shopping environment and reducing potential financial losses for retailers. The integration of this functionality into the electronic device enhances its capability to monitor and control user interactions in real-time, ensuring that potentially fraudulent activities are identified and addressed promptly.

In one or more embodiments, in an electronic device a method involves operating an electronic shopping application through one or more processors. In one or more embodiments, the processors collate a plurality of orders of products that share a common category and originate from a common geographic area. In one or more embodiments, this collation process determines a fraudulent return propensity score by comparing the plurality of orders to a historical set of orders of other products with various categories. In one or more embodiments, the method aims to identify patterns indicative of potential fraud by analyzing similarities in product categories and geographic origins.

Upon determining that the fraudulent return propensity score exceeds a predefined threshold, in one or more embodiments the processors present a prompt on a user interface of remote electronic devices responsible for the plurality of orders. This prompt serves as a notification to the users, indicating the potential for fraudulent activity based on the analyzed patterns. The prompt advantageously provides information on whether shopping cart user interaction events and/or product return user interaction events will be precluded from occurring in the electronic shopping application in one or more embodiments, thereby preventing further actions that could lead to fraudulent returns.

By collating a plurality of orders of products that share a common category and originate from a common geographic area, the method enables the determination of a fraudulent return propensity score. This approach allows for the identification of patterns indicative of potential fraud, such as coordinated purchasing behaviors within a localized area, which are not easily detectable through conventional methods.

Presenting a prompt on a user interface of remote electronic devices when the fraudulent return propensity score exceeds a predefined threshold provides users with immediate feedback regarding potentially fraudulent activity. This proactive notification system helps prevent further actions that could lead to fraudulent returns, thereby maintaining the integrity of the shopping environment and reducing potential financial losses for retailers. Other advantages will be described below. Still others will be obvious to those of ordinary skill in the art having the benefit of this disclosure.

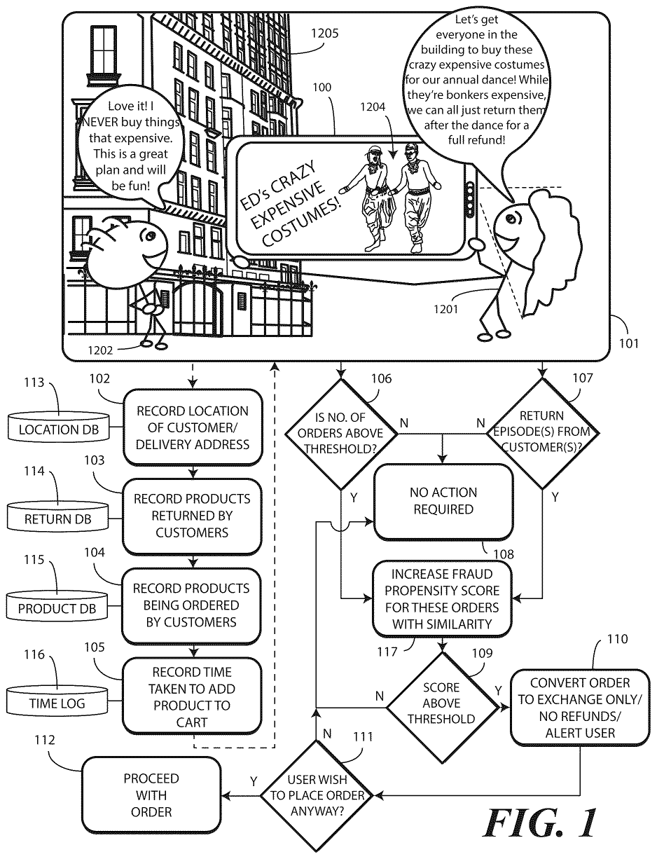

Turning now to FIG. 1, at step 101 the residents 1201,1202 are again using an electronic device 100 to concoct a scheme to order costumes 1204 from Ed's “Crazy Expensive” Costumes, only to return them sweaty and dirty right after the community hoedown is complete. Lucky for Ed, he has been apprised of embodiments of the present disclosure.

Accordingly, Ed has programmed the electronic shopping interactive computing environment operating on the one or more processors of the electronic device 100 to, in response to initiation of a plurality of interactive sessions in the electronic shopping interactive computing environment that is also operating on one or more processors of the electronic device 100, determine, by the one or more processors, a fraudulent return propensity score as a function of a plurality of shopping cart interaction events occurring in the plurality of interactive sessions in the electronic shopping interactive computing environment. In one or more embodiments, when the fraudulent return propensity score exceeds a predefined threshold, the one or more processors preclude one or more additional user interaction events from occurring in each interactive session of the plurality of interactive sessions in the electronic shopping interactive computing environment. Accordingly, embodiments of the disclosure are operable to wholly thwart the scheming plans of resident 1201 while advantageously preserving Ed's “Crazy Generous” return policy for legitimate customers.

In one or more embodiments, the determining the fraudulent return propensity score comprises, by the one or more processors, weighting a plurality of input parameters to obtain a plurality of weighted input parameters and summing the plurality of weighted input factors to obtain a raw fraudulent return propensity score. Illustrating by example, in one or more embodiments decision 106 determines whether a number of orders of a particular item, or particular category of items, is above a predefined threshold within a given community 1205.

Using Ed's “Crazy Expensive” Costumes as an example, in normal times Ed may expect a single costume 1204 to be ordered from a particular community 1205. In such a situation, the method may move from decision 106 to step 108, where no action is required. However, when three hundred costumes 1204 are ordered within a predetermined time frame from a single street address, the method of FIG. 1 may move from decision 106 to step 117, where the fraudulent return propensity score is increased.

The community 1205 can be defined in a variety of ways. In the illustrative embodiment of FIG. 1, the community 1205 is a condominium building. However, the community 1205 can be defined in other ways as well. Indeed, the community 1205 can be defined in various ways, each offering distinct characteristics and applications.

One definition involves neighborhoods, which encompass a group of residences and businesses within a specific area. This definition allows for the identification of purchasing patterns within a socially connected group, facilitating the detection of coordinated activities. Streets provide another definition, focusing on a linear arrangement of addresses. This approach enables precise tracking of transactions occurring along a specific route, aiding in pinpointing localized purchasing behaviors.

Buildings represent a further definition, concentrating on a single structure or complex. This definition is particularly useful for identifying patterns within multi-unit dwellings, such as apartment complexes, where residents may engage in collective purchasing activities. Zip codes offer a broader geographic definition, encompassing multiple neighborhoods or districts. This approach provides a regional perspective, allowing for the analysis of purchasing trends across a larger area.

Additional definitions include districts, which cover administrative or commercial zones, enabling the examination of purchasing behaviors within specific economic or regulatory boundaries. Municipalities represent another definition, focusing on city or town-level analysis, providing insights into urban purchasing patterns. Lastly, census tracts offer a statistical definition, allowing for demographic-based analysis of purchasing activities. Each definition provides insights into purchasing behaviors, facilitating the detection of coordinated activities and enhancing fraud prevention strategies. Still other definitions for the community 1205 will be obvious to those of ordinary skill in the art having the benefit of this disclosure.

Decision 107 determines whether there are abnormal return episodes from people making the orders at step 101. As shown in FIG. 1, while the electronic shopping interactive computing environment is operational on the one or more processors of the electronic device 100, many factors are monitored at steps 102-105.

Illustrating by example, in one or more embodiments the function of the plurality of shopping cart interaction events analyzed by decision 106 and 107 and used to calculate the fraudulent return propensity score has as a first input a delivery address associated with each shopping cart interaction event of the plurality of shopping cart interaction events, which is stored in a location data store 113 and monitored at step 102. Illustrating by example, in one scenario, a delivery address associated with each shopping cart interaction event, monitored at step 102, may increase a fraudulent return propensity score at step 117 when multiple users within a single residential complex consistently order identical items. This pattern suggests a coordinated effort to exploit return policies, as the proximity of the delivery addresses indicates potential collaboration among residents. The system records these addresses and identifies the frequency of similar orders, contributing to a higher propensity score.

Another use case involves a commercial district where businesses frequently order the same office supplies or equipment. If these orders originate from addresses within a close geographic area and are followed by returns citing generic reasons, the system may flag these transactions as suspicious. The repeated nature of these orders and returns from similar addresses raises the fraudulent return propensity score, prompting preventive measures.

A third example includes a festival or event where attendees order costumes or props from nearby locations. The delivery addresses, clustered around the event venue, suggest temporary use of the items. The system detects this pattern by analyzing the concentration of orders and subsequent returns from these addresses, increasing the fraudulent return propensity score and potentially converting return policies to exchange-only options.

Similarly, the function of the plurality of shopping cart interaction events can have as a second input a location from which the each shopping cart interaction event of the plurality of shopping cart interaction events originated, which can at least some be stored in a location data store 113 and monitored at step 102.

With reference to decision 107, in one or more embodiments the function of the plurality of shopping cart interaction events can have as a fourth input whether any remote electronic device engaged in the plurality of interactive sessions has caused a return user interaction event, stored in a return data store 114 and monitored at step 103, to occur within a predefined previous time period in the electronic shopping interactive computing environment. Illustrating by example, in one scenario a remote electronic device engaged in multiple interactive sessions within an electronic shopping environment records a series of return user interaction events at step 103 in the return data store 114. These events occur within a predefined previous time period, indicating a pattern of frequent returns.

In one or more embodiments, decision 107 analyzes these interactions, identifying a potential misuse of return policies. The repeated nature of these returns, especially when associated with similar products or categories, contributes to an increased fraudulent return propensity score at step 117. This score reflects the likelihood of coordinated fraudulent activities, prompting preventive measures to safeguard the shopping environment.

Another use case involves a remote electronic device that consistently initiates return user interaction events for high-value items. These returns occur shortly after purchase, within the predefined time frame, raising suspicion. Decision 107 correlates these events with the device's location data and purchase history, identifying a pattern of behavior that deviates from typical consumer activity. The fraudulent return propensity score increases at step 117 as the system detects these anomalies, allowing for targeted interventions to prevent further exploitation of return policies.

In a third example, a remote electronic device participates in interactive sessions where return user interaction events are triggered for items purchased during promotional periods. The system monitors these returns, noting their frequency and timing within the predefined period. By analyzing the device's interaction history and comparing the device's interaction history to standard consumer behavior, decision 107 identifies potential fraudulent intent. The fraudulent return propensity score rises at step 117, enabling the implementation of measures such as restricting return options or alerting the retailer to investigate further.

In still other embodiments, the function of the plurality of shopping cart interaction events has as a fourth input whether a product category, stored in a product data store 115 and monitored at step 104, is common to the each interactive session of the plurality of interactive sessions. Embodiments of the disclosure contemplate that large retailers may sell thousands and thousands of events. One condominium building simultaneously, or within the same time period, ordering a piano, a car, a toothbrush, a vest to keep and adopted rescue dog warm on winter walks, a teapot, and a Godzilla pinball machine are not within the same category. Accordingly, decision 107 would lead to step 108 where no action is required. By contrast, when fifty costumes 1204 in the same style are simultaneously ordered from a “Crazy Expensive” vendor, decision 107 would lead to an increased fraudulent return propensity score at step 117, and so forth.

Instead of, or in addition to, these other factors, in some embodiments the function of the plurality of shopping cart interaction events has as a third input an amount of time taken for the each shopping cart interaction event of the plurality of shopping cart interaction events to occur, which is stored in a time log 116 and monitored at step 105. Embodiments of the disclosure contemplate that a rapid ordering process, particularly within a specific community 1205, may suggest a coordinated effort to exploit return policies.

For instance, when a user quickly adds items to a cart and completes a purchase, this behavior may align with a premeditated plan, such as when resident 1201 instructs others on what to order. This guidance reduces the time spent on shopping cart interaction events, as users bypass the typical browsing and decision-making processes associated with genuine purchases.

Consider a scenario where multiple users in a condominium complex rapidly purchase identical items, such as costumes for a community event. The swift nature of these transactions, coupled with the uniformity of the items, raises the fraudulent return propensity score at step 117. This pattern suggests a collective scheme to use the items temporarily and return them post-event. By contrast, a user who takes time to explore various product categories and compare options demonstrates a more deliberate purchasing behavior, indicative of genuine consumer intent, leading to a lower fraudulent return propensity score at step 117.

Another example involves a festival where attendees quickly order props or attire from nearby locations. The expedited ordering process, driven by specific instructions or recommendations, points to a coordinated effort to exploit return policies. The system detects this pattern by analyzing the reduced time spent on shopping cart interactions and the concentration of similar orders. This analysis increases the fraudulent return propensity score, prompting preventive measures to safeguard the shopping environment. Still other scenarios increasing the fraudulent return propensity score will be obvious to those of ordinary skill in the art having the benefit of this disclosure.

Decision 109 determines whether the fraudulent return propensity score is above a predefined threshold. In one or more embodiments, where it is, step 110 comprises precluding one or more additional user interaction events from occurring in each interactive session of the plurality of interactive sessions in the electronic shopping interactive computing environment. The one or more additional user interaction events can vary.

Illustrating by example, in one or more embodiments when the fraudulent return propensity score exceeds a first threshold above the predefined threshold, the precluding the one or more additional user interaction events in the each interactive session at step 110 comprises precluding all user interaction events from occurring in the each interactive session of the plurality of interactive sessions in the electronic shopping interactive computing environment

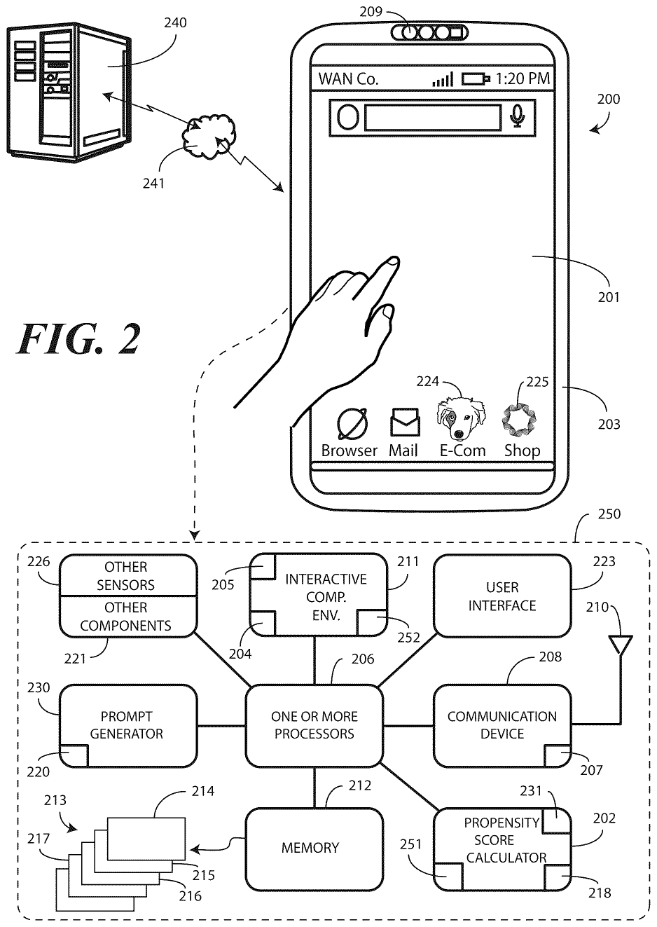

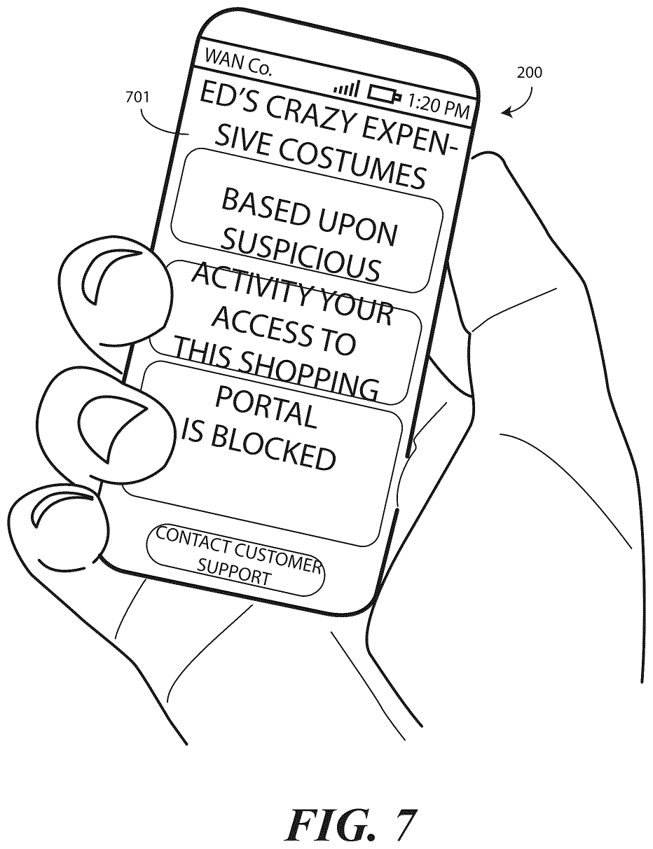

Illustrating by example, turning briefly to FIG. 7, illustrated therein is the electronic device 200 configured in accordance with embodiments of the disclosure and described below with reference to FIG. 2 displaying a first prompt 701. In one or more embodiments, this prompt 701 appears when the fraudulent return propensity score exceeds a first predefined threshold located above the predefined threshold where the one or more processors preclude one or both of shopping cart user interaction events and/or product return user interaction events from occurring in the electronic shopping application. Consequently, the one or more processors terminate the interactive shopping session after presenting the prompt 701.

The prompt 701 displayed on the electronic device 200 informs the user that access to the shopping portal is blocked due to suspicious activity. The message reads: “ED'S CRAZY EXPENSIVE COSTUMES: BASED UPON SUSPICIOUS ACTIVITY YOUR ACCESS TO THIS SHOPPING PORTAL IS BLOCKED.” This notification indicates that the system has detected behavior indicative of potential fraud and has taken preventive measures to restrict the user's access to the shopping application.

After presenting the prompt 701, the system may offer the user an option to contact customer support for further assistance. This action allows the user to address any issues or disputes regarding the blocked access. The prompt 701 includes a “CONTACT CUSTOMER SUPPORT” user actuation target, which the user can select to initiate communication with customer support representatives. This feature ensures that legitimate users who may have been incorrectly flagged can resolve the issue and regain access to the shopping application.

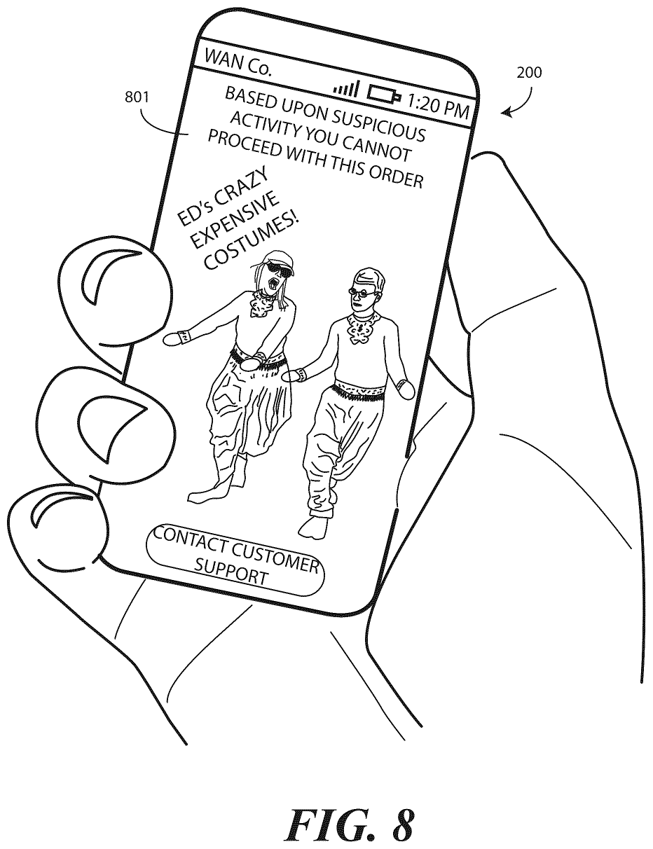

Turning now back to FIG. 1, in some embodiments, such as when the fraudulent return propensity score exceeds a second threshold located between the predefined threshold and the first threshold, but fails to exceed the first threshold, the precluding occurring at step 110 of the one or more additional user interaction events in the each interactive session comprises precluding a shopping cart completion interaction event from occurring in the each interactive session of the plurality of interactive sessions in the electronic shopping interactive computing environment. Turning now briefly to FIG. 8, illustrated therein is one explanatory prompt 801 presented on an electronic device 200 showing just such one example.

In one or more embodiments, the prompt 801 appears when the fraudulent return propensity score exceeds another predefined threshold located above the predefined threshold where the one or more processors preclude one or both of shopping cart user interaction events and/or product return user interaction events from occurring in the electronic shopping application. As a result, the one or more processors block both the shopping cart user interaction events and the product return user interaction events from occurring in the electronic shopping application.

In this illustrative embodiment, the prompt 801 informs the user that, based on suspicious activity detected on the device, the user cannot proceed with the order. The message displayed on the electronic device 200 reads: “BASED UPON SUSPICIOUS ACTIVITY YOU CANNOT PROCEED WITH THIS ORDER.” This notification indicates that the system has detected behavior indicative of potential fraud and has taken preventive measures to restrict the user's ability to place orders.

The electronic device 200 still allows interaction with the electronic shopping application, as indicated by the fact that the user interface still shows a list of products, including stylized men's and women's costumes. However, the particular order triggering presentation of the prompt 801 is not allowed. In one or more embodiments, a banner stating, “NOT ALLOWED,” can be presented. These the presentation of such banners indicate that shopping cart user interaction events are prohibited for these products, preventing the user from adding them to the shopping cart or proceeding with the purchase.

A “CONTACT CUSTOMER SUPPORT” user actuation target is also displayed on the electronic device 200. This target allows the user to contact customer support if the user believes the prompt 801 is shown in error. This feature ensures that legitimate users who may have been incorrectly flagged can resolve the issue and regain access to the shopping application.

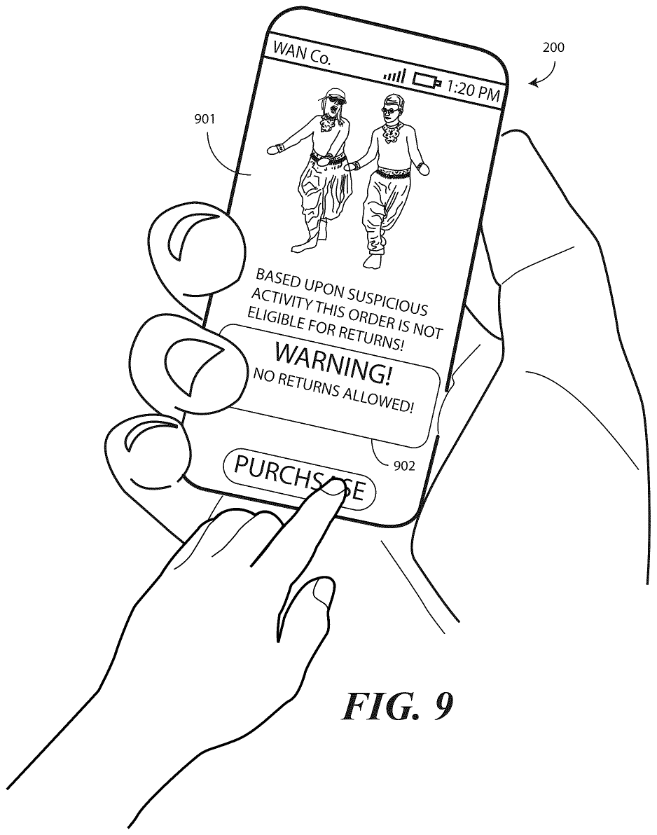

Turning now back to FIG. 1, in some embodiments, such as when the fraudulent return propensity score exceeds a third threshold located between the predefined threshold and the second threshold, but fails to exceed the second threshold, the precluding the one or more additional user interaction events in the each interactive session at step 117 comprises presenting a prompt on a user interface of remote electronic devices engaged in the plurality of interactive sessions indicating that any shopping cart completion interaction events will be unavailable for product return user interaction events in the electronic shopping interactive computing environment. Turning now to FIG. 9, illustrated therein is one such prompt 901.

Shown in FIG. 9 is the electronic device 200 presenting still another prompt 901 because the fraudulent return propensity score exceeds a predefined threshold where the one or more processors preclude product return user interaction events from occurring in the electronic shopping application. In this illustrative embodiment, the electronic device 200 displays a warning message indicating that the order is not eligible for returns due to suspicious activity detected on the device.

The prompt 901 prominently displays the product information for the selected costumes (1204). However, in addition a warning message reads: “BASED UPON SUSPICIOUS ACTIVITY THIS ORDER IS NOT ELIGIBLE FOR RETURNS!” This notification informs the user that, due to their high fraudulent return propensity score, they will not be able to return the keyboard if they decide to purchase the selected costumes (1204).

A sub-prompt 902 is also displayed, indicating “NO RETURNS ALLOWED!” This sub-prompt 902 reinforces the restriction on returns for the specified product. Despite the restriction, the user can still proceed with the purchase by selecting the “PURCHASE” button displayed on the screen.

The electronic device 200 ensures that users identified as high-risk for fraudulent returns are restricted from performing return actions, thereby protecting retailers from potential financial losses. The system leverages device-level data to calculate the fraudulent return propensity score, enhancing the accuracy of fraud detection and maintaining the integrity of the e-commerce platform.

It should be noted that the prompts 701,801,901 of FIGS. 7-9 are illustrative only. Others suitable for presentation when the fraudulent return propensity score exceeds one or more thresholds will be obvious to those of ordinary skill in the art having the benefit of this disclosure.

Turning now back to FIG. 1, decision 111 determines, presuming the fraudulent return propensity score is not high enough to preclude all user interaction events with the electronic shopping interactive computing environment or shopping cart completion interaction events, whether the purchaser still wants to make the purchase. If they do, the a shopping cart completion event occur at step 112. Otherwise, no action is required at step 108.

Turning now to FIG. 2, illustrated therein is one explanatory electronic device 200 configured in accordance with one or more embodiments of the disclosure. The electronic device 200 of this illustrative embodiment includes a user interface 223. In one or more embodiments, the user interface 223 comprises a display 201, which may optionally be touch-sensitive. The display 201 can serve as a primary user interface 223 of the electronic device 200.

Where the display 201 is touch sensitive, users can deliver user input to the display 201 by delivering touch input from a finger, stylus, or other objects disposed proximately with the display. In one embodiment, the display 201 is configured as an active-matrix organic light emitting diode (AMOLED) display. However, it should be noted that other types of displays, including liquid crystal displays, would be obvious to those of ordinary skill in the art having the benefit of this disclosure.

The explanatory electronic device 200 of FIG. 2 includes a housing 203. Features can be incorporated into the housing 203. Examples of features that can be included along the housing 203 include an imager 209, shown as a camera in FIG. 2, or an optional speaker port. A user interface component, which may be a button or touch sensitive surface, can also be disposed along the housing 203.

A block diagram schematic 250 of the electronic device 200 is also shown in FIG. 2. In one embodiment, the electronic device 200 includes one or more processors 206. In one embodiment, the one or more processors 206 can include an application processor and, optionally, one or more auxiliary processors. One or both of the application processor or the auxiliary processor(s) can include one or more processors. One or both of the application processor or the auxiliary processor(s) can be a microprocessor, a group of processing components, one or more Application Specific Integrated Circuits (ASICs), programmable logic, or other type of processing device.

The application processor and the auxiliary processor(s) can be operable with the various components of the electronic device 200. Each of the application processor and the auxiliary processor(s) can be configured to process and execute executable software code to perform the various functions of the electronic device 200. A storage device, such as memory 212, can optionally store the executable software code used by the one or more processors 206 during operation.

In this illustrative embodiment, the electronic device 200 also includes a communication device 208 that can be configured for wired or wireless communication with one or more other devices or networks. The networks can include a wide area network, a local area network, and/or personal area network. The communication device 208 may also utilize wireless technology for communication, such as, but are not limited to, peer-to-peer, or ad hoc communications such as HomeRF, Bluetooth and IEEE 802.11 based communication, or alternatively via other forms of wireless communication such as infrared technology. The communication device 208 can include wireless communication circuitry, one of a receiver, a transmitter, or transceiver, and one or more antennas 210.

The electronic device 200 can optionally include a near field communication circuit 207 used to exchange data, power, and electrical signals between the electronic device 200 and another electronic device. In one embodiment, the near field communication circuit 207 is operable with a wireless near field communication transceiver, which is a form of radio-frequency device configured to send and receive radio-frequency data to and from the companion electronic device or other near field communication objects.

Where included, the near field communication circuit 207 can have its own near field communication circuit controller in one or more embodiments to wirelessly communicate with companion electronic devices using various near field communication technologies and protocols. The near field communication circuit 207 can include—as an antenna—a communication coil that is configured for near-field communication at a particular communication frequency.

The term “near-field” as used herein refers generally to a distance of less than about a meter or so. The communication coil communicates by way of a magnetic field emanating from the communication coil when a current is applied to the coil. A communication oscillator applies a current waveform to the coil. The near field communication circuit controller may further modulate the resulting current to transmit and receive data, power, or other communication signals with companion electronic devices.

In one embodiment, the one or more processors 206 can be responsible for performing the primary functions of the electronic device 200. For example, in one embodiment the one or more processors 206 comprise one or more circuits operable to present presentation information, such as images, text, and video, on the display 201. When an electronic shopping application 225 is actuated, the one or more processors 206 can present an electronic shopping interactive computing environment 205 to a user on the display 201, within which the user can enter an interactive session 204 and make user interaction events. The executable software code used by the one or more processors 206 can be configured as one or more modules 213 that are operable with the one or more processors 206. Such modules 213 can store instructions, control algorithms, and so forth.

In one embodiment, the one or more processors 206 are responsible for running the operating system environment 214. The operating system environment 214 can include a kernel, one or more drivers, and an application service layer 215, and an application layer 216. The operating system environment 214 can be configured as executable code operating on one or more processors or control circuits of the electronic device 200.

The application service layer 215 can be responsible for executing application service modules. The application service modules may support one or more applications 217 or “apps.” Examples of such applications include a cellular telephone application for making voice telephone calls, a web browsing application configured to allow the user to view webpages on the display 201 of the electronic device 200, an electronic mail application configured to send and receive electronic mail, a photo application configured to organize, manage, and present photographs on the display 201 of the electronic device 200, and a camera application for capturing images with the imager 209.

Collectively, these applications constitute an “application suite.” In one or more embodiments, these applications comprise one or more e-commerce applications 224 and/or electronic shopping applications 225 that allow electronic commerce orders to be placed and financial transactions to be made using the electronic device 200.

Illustrating by example, in one or more embodiments a user can deliver user input to an e-commerce application 224 to launch an interactive session 204 of an electronic shopping interactive computing environment 211 that operates on the one or more processors 206. They can then deliver user input to the user interface 223 to define one or more search strings corresponding to one or more categories within the electronic shopping interactive computing environment 211. The one or more processors 206 can then monitor user interaction events in the electronic shopping interactive computing environment 211 to determine a fraudulent return propensity score 231 as previously described above with reference to FIGS. 1 and 7-9.

In one or more embodiments, in response to the one or more processors 206 detecting commencement of an interactive session 204 of an electronic shopping application 225 operating on the one or more processors 206, the one or more processors 206, using a propensity score calculator 202, can determine a fraudulent return propensity score 231. In one or more embodiments, the propensity score calculator 202 stores one or more fraudulent return propensity score thresholds 218. In one or more embodiments, when the fraudulent return propensity score 231 exceeds a predefined threshold of the one or more fraudulent return propensity score predefined thresholds 218, the one or more processors 206 preclude one or both of shopping cart user interaction events and/or product return user interaction events from occurring in the electronic shopping application 225.

In one or more embodiments, when the fraudulent return propensity score 231 exceeds another predefined threshold of the one or more fraudulent return propensity score predefined thresholds 218 located above the predefined threshold, the one or more processors 206 terminate the interactive shopping session. In one or more embodiments, when the fraudulent return propensity score 231 exceeds another predefined threshold of the one or more fraudulent return propensity score predefined thresholds 218 located above the predefined threshold the one or more processors 206 block both the shopping cart user interaction events and the product return user interaction events from occurring in the electronic shopping application 225. In one or more embodiments, when the fraudulent return propensity score 231 falls between the predefined threshold and the another predefined threshold the one or more processors 206 block only the product return user interaction events from occurring in the electronic shopping application 225.

In one or more embodiments, the one or more processors 206 further cause the user interface 223 to present a prompt 220 identifying which of the one or both of the shopping cart user interaction events and/or the product return user interaction events is precluded from occurring in the electronic shopping application 225. In one or more embodiments, a prompt generator 230 generates this prompt. Examples of such prompts were described above with reference to FIGS. 5-7.

In one or more embodiments the one or more processors 206 are responsible for managing the applications and all personal information received from the user interface 223 that is to be used by the e-commerce application 224 and/or electronic shopping application 225 after the electronic device 200 is authenticated as a secure electronic device and the user identification credentials have triggered an electronic payment transaction request to complete an electronic shopping cart interaction event. The one or more processors 206 can also be responsible for launching, monitoring, and killing the various applications and the various application service modules. In one or more embodiments, the one or more processors 206 are operable to not only kill the applications, but also to expunge any and all personal data, data, files, settings, or other configuration tools when the electronic device 200 is reported stolen or when the e-commerce application 224 and/or electronic shopping application 225 are used with fraudulent activity to wipe the memory 212 clean of any personal data, preferences, or settings of the person previously using the electronic device 200.

The one or more processors 206 can also be operable with other components 221. The other components 221, in one embodiment, include input components, which can include acoustic detectors as one or more microphones. The one or more processors 206 may process information from the other components 221 alone or in combination with other data, such as the information stored in the memory 212 or information received from the user interface.

The other components 221 can include a video input component such as an optical sensor, another audio input component such as a second microphone, and a mechanical input component such as button. The other components 221 can include one or more sensors 226, which may include key selection sensors, touch pad sensors, capacitive sensors, motion sensors, and switches. Similarly, the other components 221 can include video, audio, and/or mechanical outputs.

The one or more sensors 226 may include, but are not limited to, accelerometers, touch sensors, surface/housing capacitive sensors, audio sensors, and video sensors. Touch sensors may be used to indicate whether the electronic device 200 is being touched at side edges. The other components 221 of the electronic device can also include a device interface to provide a direct connection to auxiliary components or accessories for additional or enhanced functionality and a power source, such as a portable battery, for providing power to the other internal components and allow portability of the electronic device 200.

In one or more embodiments, the electronic device 200 comprises a prompt generator 230 as well. In one or more embodiments, the prompt generator generates a prompt 220 identifying whether the one or both of shopping cart user interaction events and/or product return user interaction events will be precluded from occurring in the electronic shopping interactive computing environment 205. In one or more embodiments, the prompt 220 is presented by the one or more processors 206 on the user interface 223 in response to the normalized fraudulent return propensity score 231 exceeding a predefined threshold.

In one or more embodiments, in response to the one or more processors 206 detecting a plurality of shopping cart interaction events 251 occurring in a plurality of interactive shopping sessions occurring in an electronic shopping application 225 operating on the one or more processors 206, the one or more processors 206 determine a fraudulent return propensity score 231 as a function of one or more factors. In one or more embodiments, the one or more factors comprise a product category and a location area associated with each shopping cart interaction event being common across the each shopping cart interaction event of the plurality of shopping cart interaction events 251.

In one or more embodiments, when the fraudulent return propensity score 231 exceeds a predefined threshold, the one or more processors 206 preclude one or both of the plurality of shopping cart user interaction events 251 and/or a plurality of product return user interaction events corresponding to the plurality of shopping cart interaction events 251 from occurring in the electronic shopping application 225, as previously described. In one or more embodiments, when the fraudulent return propensity score 231 exceeds another predefined threshold located above the predefined threshold the one or more processors 206 terminate the plurality of interactive shopping sessions.

In one or more embodiments, when the fraudulent return propensity score 231 exceeds another predefined threshold located above the predefined threshold the one or more processors 206 block both the plurality of shopping cart user interaction events 251 and the plurality of product return user interaction events from occurring in the electronic shopping application 225. In still other embodiments, when the fraudulent return propensity score 231 falls between the predefined threshold and the another predefined threshold the one or more processors 206 block only the plurality of product return user interaction events from occurring in the electronic shopping application 225.

In one or more embodiments, the one or more processors 206 further cause the user interface 223 to present a prompt 220 identifying which of the one or both of the plurality of shopping cart user interaction events 251 and/or the plurality of product return user interaction events 252 is precluded from occurring in the electronic shopping application 225. In one or more embodiments, the prompt 220 is presented only when the one or more processors 206 detect at least one product return user interaction event corresponding to shopping cart interaction events occurring in the electronic shopping interactive computing environment 205 within a predefined prior duration occurring before commencement of the electronic shopping interactive computing environment 205.

In one or more embodiments, the propensity score calculator 202 and the prompt generator 230 can be operable with one or more processors 206, configured as a component of the one or more processors 206, or configured as one or more executable code modules operating on the one or more processors 206. In other embodiments, the propensity score calculator 202 and the prompt generator 230 can be standalone hardware components operating executable code or firmware to perform their functions. Other configurations for the propensity score calculator 202 and the prompt generator 230 will be obvious to those of ordinary skill in the art having the benefit of this disclosure.

It is to be understood that FIG. 2 is provided for illustrative purposes only and for illustrating components of one electronic device 200 in accordance with embodiments of the disclosure and is not intended to be a complete schematic diagram of the various components required for an electronic device. Therefore, other electronic devices in accordance with embodiments of the disclosure may include various other components not shown in FIG. 2 or may include a combination of two or more components or a division of a particular component into two or more separate components, and still be within the scope of the present disclosure.

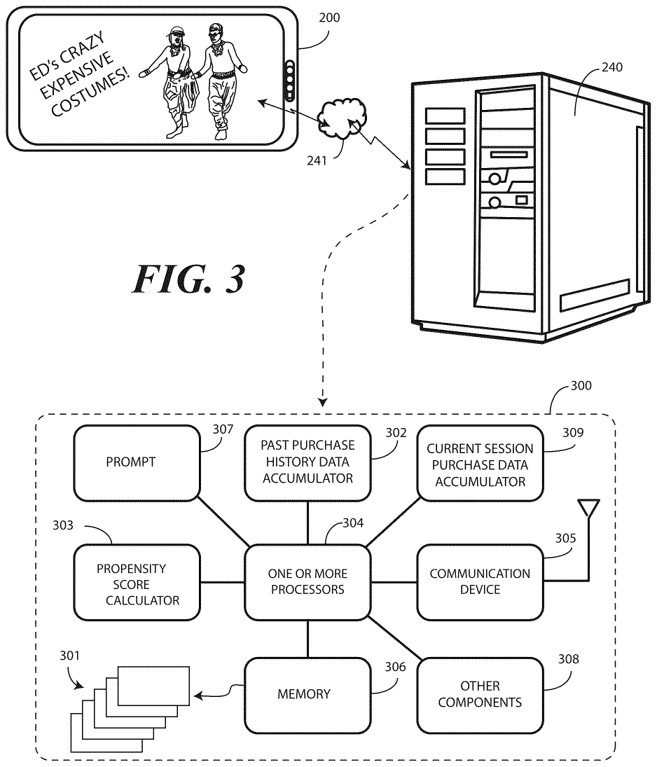

In one or more embodiments, the electronic device 20 is operable with a networked electronic device 240 and communicates with the networked electronic device 240 across a network. In one or more embodiments, the networked electronic device 240 operates the electronic shopping application 225, while the electronic device 200 serves as a client device to the networked electronic device 240. Turning now to FIG. 3, illustrated therein is a networked electronic device 240 that communicates with one or more remote electronic devices, one example of which is electronic device 200, across a network 241.

Embodiments of the disclosure can function both locally on a user's electronic device 200 or, alternatively on networked electronic devices 240. In one or more embodiments, the networked electronic device 240 operates as a central server, while one or more remote electronic devices act as clients. This configuration allows for the electronic shopping application (225) to manage and analyze data across multiple devices, enhancing the detection of fraudulent return patterns. By leveraging the networked electronic device 240, the system can collate a plurality of orders from different users, identifying common categories and geographic areas. This centralized approach enables a comprehensive analysis of purchasing behaviors, facilitating the calculation of a fraudulent return propensity score.

In one or more embodiments, the use of a networked electronic device 240 provides a robust platform for processing and comparing orders against historical data. This setup allows for the identification of patterns indicative of potential fraud, such as coordinated purchasing activities within a localized area. The networked electronic device 240 can efficiently present prompts on user interfaces of remote electronic devices when the fraudulent return propensity score exceeds a predefined threshold. This prompt serves as a notification to users, indicating potentially fraudulent activity and precluding certain user interaction events. The integration of networked electronic devices thus enhances the system's ability to maintain the integrity of return policies and reduce financial losses for retailers.

In one or more embodiments, one or more processors 206 of the networked electronic device 240 operate an electronic shopping application (225). In one or more embodiments, a current session purchase data accumulator 309 collates a plurality of orders of products having a common category and originating from a common geographic area so that a propensity score calculator 303 can determine a fraudulent return propensity score when the plurality of orders are compared to a historical set of orders of other products having a plurality of categories that are monitored by a past purchase history data accumulator 302. In one or more embodiments, the one or more processors 304 present, on a user interface of remote electronic devices responsible for the plurality of orders, and in response to the fraudulent return propensity score exceeding a predefined threshold, a prompt 307 as previously described.

In one or more embodiments, the prompt 307 identifies whether the one or both of shopping cart user interaction events and/or product return user interaction events will be precluded from occurring in the electronic shopping application. In one or more embodiments, the prompt 307 is presented only when the one or more processors detect an amount of time used to place each order of the plurality of orders being less than an average amount of time used to place each historical order of the historical set of orders by a predefined amount. In one or more embodiments, the prompt 307 is presented only when the one or more processors detect a delivery address of the each order of the plurality of orders is within a predefined distance of each other order of the plurality of orders

As with the block diagram schematic (250) of FIG. 2, it is to be understood that the schematic block diagram 300 of FIG. 3 is provided for illustrative purposes only and for illustrating components of one explanatory networked electronic device 240 configured in accordance with one or more embodiments of the disclosure. Accordingly, the components shown in either FIG. 2 or FIG. 3 are not intended to be complete schematic diagrams of the various components required for a particular device, as other devices configured in accordance with embodiments of the disclosure may include various other components not shown in FIG. 2 or FIG. 3. Alternatively, other networked electronic devices 240 configured in accordance with embodiments of the disclosure or may include a combination of two or more components or a division of a particular component into two or more separate components, and still be within the scope of the present disclosure.

In one or more embodiments the networked electronic device 240 can be configured with performing processor-intensive methods, operations, steps, functions, or procedures associated with the operation of an electronic shopping application operating across a plurality of remote electronic devices, as well as the presentation of the aforementioned prompts when a fraudulent return propensity score exceeds a predefined threshold. Illustrating by example, the networked electronic device 240 can be configured to, in response to the one or more processors 304 detecting a plurality of shopping cart interaction events occurring in a plurality of interactive shopping sessions occurring in an electronic shopping application operating on the one or more processors, determine a fraudulent return propensity score as a function of a product category and a location area associated with each shopping cart interaction event being common across the each shopping cart interaction event of the plurality of shopping cart interaction events. In one or more embodiments when the fraudulent return propensity score exceeds a predefined threshold, the one or more processors 304 preclude one or both of the plurality of shopping cart user interaction events and/or a plurality of product return user interaction events corresponding to plurality of shopping cart interaction events from occurring in the electronic shopping application.

In one or more embodiments, the networked electronic device 240 includes one or more memory devices 306, and one or more user interface devices, e.g., a display, a keyboard, a mouse, audio input devices, audio output devices, and alternate visual output devices. The networked electronic device 240 also includes a communication device 305. These components can be operatively coupled together such that, for example, the one or more processors 304 are operable with the one or more memory devices 306, the one or more user interface devices, the communication device 305, and/or other components 308 of the networked electronic device 240 in one or more embodiments.

The one or more processors 304 can include a microprocessor, a group of processing components, one or more ASICs, programmable logic, or other type of processing device. The one or more processors 304 can be configured to process and execute executable software code to perform the various functions of the networked electronic device 240.

The one or more memory devices 306 can optionally store the executable software code used by the one or more processors 304 in carrying out the operations of the electronic shopping application system. The one or more memory devices 306 may include either or both of static and dynamic memory components. The one or more memory devices 306 can store both embedded software code and user data.

In one or more embodiments, the one or more processors 304 can define one or more process engines. For instance, the software code stored within the one or more memory devices 306 can embody program instructions and methods to operate the various functions of the networked electronic device 240, and also to execute software or firmware applications and modules such as the past purchase history data accumulator 302 and/or the current session purchase data accumulator 309, which can be configured as one or more modules 301 stored in the memory 306.

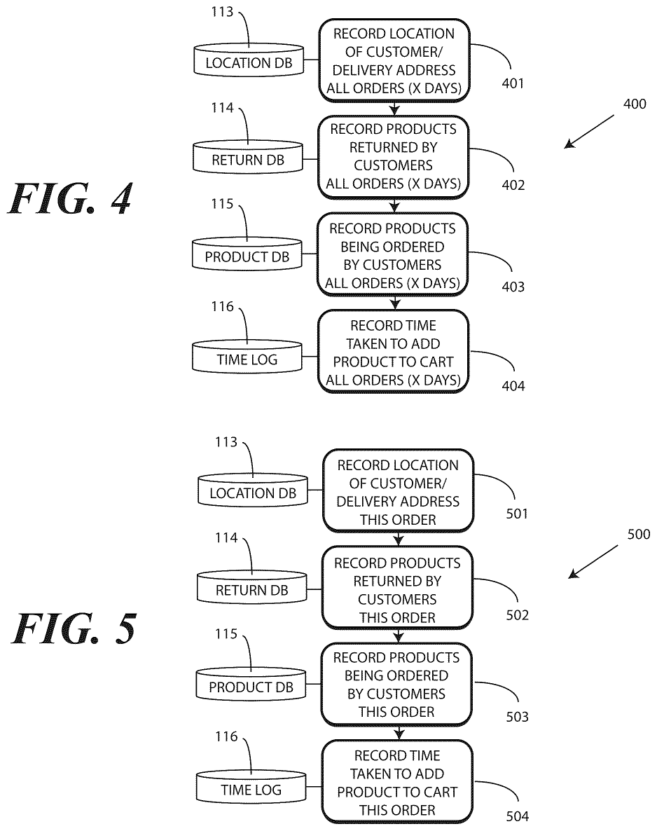

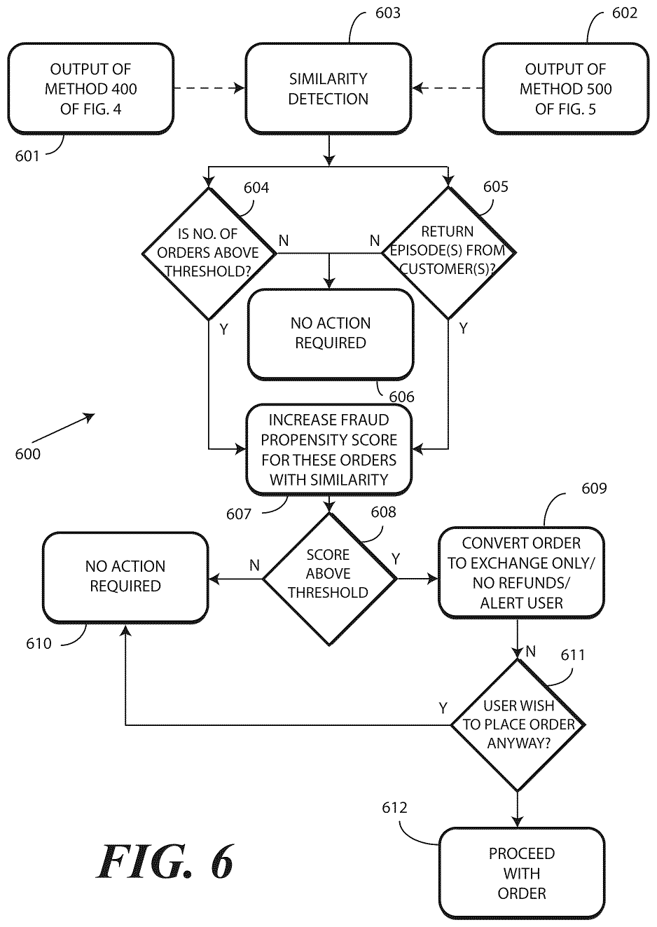

Turning now to FIG. 4, illustrated therein is one explanatory method 400 in accordance with one or more embodiments of the disclosure. In one or more embodiments, the method 400 of FIG. 4 operates within an electronic shopping interactive computing environment to systematically record data for all shopping cart completion events. This process can involve capturing specific data points such as the product category, delivery address, and user location associated with each shopping cart completion event. By aggregating this information, the system can identify patterns indicative of potentially fraudulent activities, such as repeated purchases of similar items within a localized area. The method 400 leverages the computing capabilities of the electronic device to ensure that all relevant data is accurately recorded and stored for analysis.

Recording data for all shopping cart completion events provides a comprehensive dataset that enhances the ability to detect coordinated purchasing behaviors. This dataset allows the system to calculate a fraudulent return propensity score by comparing current shopping patterns with historical data. When the score exceeds a predefined threshold, the system can implement preventive measures, such as converting return policies to exchange-only options or blocking further purchases. This proactive approach helps maintain the integrity of return policies and reduces financial losses for retailers by mitigating the impact of fraudulent returns.

In the context of embodiments of the disclosure, this method 400 supports the overall goal of preserving a fair shopping environment for genuine customers. By identifying and addressing potential fraud, the system ensures that return policies remain viable and that retailers can offer competitive pricing without the burden of fraudulent activities. The integration of this method into electronic shopping applications enhances their functionality, providing a robust framework for monitoring and controlling user interactions in real-time.

In one or more embodiments, step 401 of the method 400 in FIG. 4 involves recording the locations of customers and delivery addresses in a location data store 113 over a predefined number of days. This process can be accomplished by utilizing various data collection techniques. One approach involves capturing the IP address of the device used for placing the order, which provides an approximate geographic location of the customer. This technique offers the advantage of being non-intrusive and can be implemented without requiring additional user input. Another technique involves using GPS data from mobile devices, which provides precise location information. This method is beneficial for accuracy, allowing for detailed analysis of purchasing patterns within specific geographic areas.

Additionally, step 401 can incorporate the use of delivery address data provided during the checkout process. By storing this information in the location data store 113, the system can identify clusters of similar orders within a localized area. This approach directly correlates with the delivery logistics, enabling the detection of coordinated purchasing behaviors. Furthermore, step 401 can utilize historical data analysis to compare current location patterns with past trends, enhancing the ability to identify anomalies indicative of potential fraud. Each of these techniques contributes to a comprehensive dataset that supports the calculation of a fraudulent return propensity score, facilitating the implementation of preventive measures when necessary.

In one or more embodiments, step 402 of the method 400 in FIG. 4 involves recording products returned by customers over a predefined number of days in a return data store 114. This process can utilize various techniques to ensure accurate and comprehensive data collection. One approach involves integrating return data directly from the e-commerce platform's database, capturing details such as product identifiers, return reasons, and timestamps. This method provides a seamless and automated way to gather return information, reducing manual input errors and ensuring consistency across records.

Another technique employs barcode scanning at return processing centers. By scanning returned items, the system can instantly log product details and associate them with the corresponding order. This method enhances efficiency in handling returns and minimizes discrepancies in data entry. Additionally, barcode scanning can facilitate real-time updates to inventory systems, ensuring accurate stock levels and aiding in inventory management.

Utilizing customer feedback forms during the return process offers another method for recording return data. Customers can provide specific reasons for returns, which can be analyzed to identify patterns or common issues with certain products. This qualitative data complements quantitative return records, offering insights into customer satisfaction and potential product improvements. By employing these techniques, the system can effectively monitor return activities, contributing to the calculation of a fraudulent return propensity score and enabling the implementation of preventive measures when necessary.

Step 403 of the method 400 in FIG. 4 involves recording products ordered by customers over a predefined number of days in a product data store 115. This process can utilize various techniques to ensure accurate and comprehensive data collection. One approach involves integrating order data directly from the e-commerce platform's database, capturing details such as product identifiers, order timestamps, and customer information. This method provides a seamless and automated way to gather order information, reducing manual input errors and ensuring consistency across records.

Another technique employs the use of tracking cookies or session identifiers on the e-commerce platform. By associating these identifiers with specific customer sessions, the system can log product details and associate them with the corresponding orders. This method enhances the ability to track customer behavior and purchasing patterns, providing insights into consumer preferences and trends. Additionally, tracking cookies can facilitate real-time updates to inventory systems, ensuring accurate stock levels and aiding in inventory management.

Utilizing customer feedback forms during the order process offers another method for recording order data. Customers can provide specific reasons for their purchases, which can be analyzed to identify patterns or common preferences for certain products. This qualitative data complements quantitative order records, offering insights into customer satisfaction and potential product improvements. By employing these techniques, the system can effectively monitor order activities, contributing to the calculation of a fraudulent return propensity score and enabling the implementation of preventive measures when necessary.

Step 404 of the method 400 in FIG. 4 involves recording the time taken to order products by customers over a predefined number of days in a time log 116. This process can utilize various techniques to ensure accurate and comprehensive data collection. One approach involves integrating timestamps directly from the e-commerce platform's database, capturing the exact time each product is added to the cart and the order is finalized. This method provides a seamless and automated way to gather time-related information, reducing manual input errors and ensuring consistency across records.

Another technique employs session tracking on the e-commerce platform. By associating session identifiers with specific customer interactions, the system can log the duration of each shopping session and the time taken to complete orders. This method enhances the ability to track customer behavior and purchasing patterns, providing insights into consumer decision-making processes. Additionally, session tracking can facilitate real-time updates to the time log 116, ensuring accurate data for analysis.

Utilizing customer feedback forms during the order process offers another method for recording time data. Customers can provide specific reasons for their purchase timing, which can be analyzed to identify patterns or common preferences for certain products. This qualitative data complements quantitative time records, offering insights into customer satisfaction and potential product improvements. By employing these techniques, the system can effectively monitor order timing activities, contributing to the calculation of a fraudulent return propensity score and enabling the implementation of preventive measures when necessary.

The method 400 of FIG. 4 thus systematically records data for all shopping cart completion events, establishing a comprehensive baseline for detecting potentially fraudulent return plans. This baseline includes specific data points such as product category, delivery address, and user location associated with each shopping cart completion event. By aggregating this information, the system identifies patterns indicative of potentially fraudulent activities, such as repeated purchases of similar items within a localized area. The method 400 leverages the computing capabilities of the electronic device to ensure accurate data recording and storage for analysis.

Recording data for all shopping cart completion events provides a robust dataset that enhances the ability to detect coordinated purchasing behaviors. When combined with the method (500) of FIG. 5, This dataset allows the system to calculate a fraudulent return propensity score by comparing current shopping patterns with historical data. When the score exceeds a predefined threshold, the system can implement preventive measures, such as converting return policies to exchange-only options or blocking further purchases. This proactive approach helps maintain the integrity of return policies and reduces financial losses for retailers by mitigating the impact of fraudulent returns.

Turning now to FIG. 5, illustrated therein is another method 500 that identifies anomalies such as an excessive number of items ordered from a specific location, orders placed by individuals with high return rates, unusually expensive orders, or orders completed in an unusually short time. By analyzing these factors, the method 500 can detect patterns that deviate from typical consumer behavior, indicating potential fraud. The integration of this method 500 into electronic shopping applications enhances their functionality, providing a robust framework for monitoring and controlling user interactions in real-time.

In one or more embodiments, step 501 of the method 500 systematically records the location of individual customers and their delivery addresses in the location data store 113 on an individual order basis. This process involves capturing specific data points such as the geographic location of the customer at the time of order placement and the delivery address associated with each order. The system utilizes various data collection techniques to ensure accuracy and comprehensiveness. For instance, the system may capture the IP address of the device used for placing the order, providing an approximate geographic location of the customer. Additionally, GPS data from mobile devices can offer precise location information, enhancing the ability to analyze purchasing patterns within specific geographic areas.

During the checkout process, the system records the delivery address provided by the customer. This information is stored in the location data store 113, allowing the system to identify clusters of similar orders within a localized area. By correlating the geographic location of the customer with the delivery address, the system can detect coordinated purchasing behaviors that may indicate potential fraud. The integration of these data points into the location data store 113 supports the calculation of a fraudulent return propensity score, facilitating the implementation of preventive measures when necessary.

Step 502 of the method 500 in FIG. 5 involves recording whether a user currently making purchases has an abnormal history of returning products in the return data store 114. This process can utilize various techniques to ensure accurate and comprehensive data collection. One approach involves analyzing historical return data associated with the user's account, capturing details such as frequency of returns, reasons provided, and the time frame within which returns occur. By comparing this data against established benchmarks or thresholds, the system can identify patterns indicative of abnormal return behavior.

Another technique employs machine learning algorithms to assess the user's return history. These algorithms can analyze multiple variables, including the types of products returned, the timing of returns, and any correlations with specific events or promotions. By leveraging predictive analytics, the system can determine the likelihood of future returns based on past behavior, enhancing the accuracy of fraud detection.

Additionally, the system may incorporate feedback from customer service interactions, where users provide explanations for their returns. This qualitative data can offer insights into the user's intent and satisfaction levels, complementing quantitative return records. By integrating these techniques, the system effectively monitors return activities, contributing to the calculation of a fraudulent return propensity score and enabling the implementation of preventive measures when necessary.

Step 503 of the method 500 involves recording products ordered by an individual making user interaction events in an electronic shopping interactive computing environment. This process utilizes the product data store 115 to capture and store detailed information about each product ordered. The system integrates order data directly from the e-commerce platform's database, ensuring that product identifiers, order timestamps, and customer information are accurately recorded. This integration provides a seamless and automated method for gathering order information, reducing manual input errors and maintaining consistency across records.

Additionally, the system employs tracking cookies or session identifiers to associate specific customer sessions with the corresponding orders. This technique enhances the ability to track customer behavior and purchasing patterns, offering insights into consumer preferences and trends. By logging product details and associating them with the corresponding orders, the system ensures comprehensive data collection. This data supports the calculation of a fraudulent return propensity score, facilitating the implementation of preventive measures when necessary.

Furthermore, customer feedback forms during the order process offer another method for recording order data. Customers can provide specific reasons for their purchases, which can be analyzed to identify patterns or common preferences for certain products. This qualitative data complements quantitative order records, offering insights into customer satisfaction and potential product improvements. By employing these techniques, the system effectively monitors order activities, contributing to the overall goal of preserving a fair shopping environment for genuine customers.

Step 504 of the method 500 involves recording the amount of time taken to order products by an individual making user interaction events in an electronic shopping interactive computing environment. This process utilizes the time log 116 to capture precise timestamps for each interaction event, including when a product is added to the cart and when the order is finalized. The system integrates this data directly from the e-commerce platform's database, ensuring accuracy and consistency across records.

Session tracking enhances this process by associating session identifiers with specific customer interactions, allowing the system to log the duration of each shopping session. This method provides insights into consumer decision-making processes and purchasing patterns. Additionally, session tracking facilitates real-time updates to the time log 116, ensuring that all relevant data is available for analysis.

By employing these techniques, the system effectively monitors order timing activities, contributing to the calculation of a fraudulent return propensity score. This comprehensive approach enables the identification of patterns indicative of potential fraud, such as unusually rapid ordering processes, and supports the implementation of preventive measures when necessary.

Turning now to FIG. 6, illustrated therein is a method 600 that takes the generalized output from the method (400) of FIG. 4 at step 601 and the individualize output of the method (500) of FIG. 6 at step 602 to perform similarity detection at step 603 to collate a plurality of orders of products having a common category and originating from a common geographic area determining to determine a fraudulent return propensity score when the plurality of orders are compared to a historical set of orders of other products having a plurality of categories and present, in response to the fraudulent return propensity score exceeding a predefined threshold, a prompt.

In one or more embodiments, step 603 of the method 600 in FIG. 6 involves performing similarity detection across customers by analyzing order data within a predefined number of past days. The process begins by fetching the number of orders for similar products purchased by individuals from the same locality. This locality is determined based on geographic data such as IP addresses, GPS coordinates, or delivery addresses. The system identifies clusters of orders originating from a specific area, allowing for the detection of coordinated purchasing behaviors.

The method utilizes a data aggregation approach to collate information on product similarities. Products are considered similar if they share common attributes, such as SKU embodiment or belonging to the same sub-category. By comparing these attributes across orders, the system identifies patterns indicative of potential fraud. The analysis includes examining the frequency and timing of orders, ensuring that the detection process accounts for both recent and historical purchasing trends.

Once the system identifies a pattern of similar orders from the same locality, the system calculates a fraudulent return propensity score. This score reflects the likelihood of coordinated fraudulent activities, such as temporary use of items followed by returns. The method leverages this score to implement preventive measures, such as modifying return policies or alerting retailers to investigate further. This approach enhances the ability to maintain the integrity of return policies and reduce financial losses for retailers.

To wit, in one or more embodiments decision 604 of the method 600 in FIG. 6 involves determining whether the number of orders originating from a common locality or nearby set of addresses exceeds a predefined threshold. This process can utilize geographic data such as IP addresses, GPS coordinates, or delivery addresses to identify clusters of orders from specific areas. By analyzing these data points, the system detects patterns indicative of coordinated purchasing behaviors, which may suggest potential fraud.

The predefined threshold serves as a benchmark for identifying unusual order volumes from a particular locality. For instance, a threshold of ten orders within a 24-hour period from a single street address may indicate a coordinated effort. Similarly, a threshold of fifty orders from a neighborhood within a week could suggest a pattern of temporary use followed by returns. These thresholds are illustrative and can be adjusted based on historical data, geographic size, and typical purchasing behaviors in the area.

Other predefined thresholds will be apparent to those skilled in the art, considering factors such as population density, regional purchasing trends, and the nature of the products involved. The flexibility in setting these thresholds allows the system to adapt to various contexts, enhancing the system's ability to detect and mitigate fraudulent activities effectively.

Decision 605 of the method 600 in FIG. 6 involves determining whether a return episode has occurred among customers placing the number of orders considered at decision 604. This determination focuses on identifying patterns of returns that originate from a common locality or nearby set of addresses. The process utilizes historical return data to assess whether any of the customers involved in the current orders have previously engaged in return activities. By analyzing this data, the system identifies potential return patterns that may indicate coordinated efforts to exploit return policies.

The method employs a data aggregation approach to collate return information associated with the customers'orders. This includes examining the frequency and timing of returns, as well as any correlations with specific products or categories. The analysis considers both recent and historical return trends, ensuring a comprehensive evaluation of customer behavior. The system calculates a return propensity score based on these patterns, reflecting the likelihood of problematic returns.

When the return propensity score exceeds a predefined threshold, the system implements preventive measures to mitigate potentially fraudulent activities. These measures may include modifying return policies, alerting retailers to investigate further, or restricting future purchases. The flexibility in setting predefined thresholds allows the system to adapt to various contexts, enhancing the ability to detect and address fraudulent return schemes effectively. Other predefined thresholds will be apparent to those skilled in the art, considering factors such as product type, return frequency, and geographic location.

When decision 604 of FIG. 6 identifies that the number of orders originating from a common locality or nearby addresses surpasses the predefined threshold, and decision 605 evaluates that return episodes have occurred among the customers placing these orders, the method 600 moves to step 607 because the system recognizes a pattern indicative of potentially fraudulent activity. This pattern suggests coordinated purchasing and returning behavior, which may exploit return policies for temporary use of products.

Upon confirming both the excessive number of orders and the presence of return episodes, the system increases the fraudulent return propensity score at step 607. This increase reflects the heightened likelihood of fraudulent returns, prompting the system to consider preventive measures. These measures may include modifying return policies, alerting retailers, or restricting future purchases to mitigate potential financial losses.

If decision 605 does not detect any return episodes, the system concludes that the purchasing behavior does not align with fraudulent patterns in one or more embodiments. Consequently, no action is taken at step 606, allowing the orders to proceed without intervention. This approach ensures that genuine purchasing activities remain unaffected while maintaining vigilance against potential fraud.

Decision 608 involves determining whether the fraudulent return propensity score, calculated at step 607, exceeds a predefined threshold. This score results from comparing a plurality of current orders to a historical set of orders within the same product categories. The process begins by analyzing patterns in the current orders, such as frequency, timing, and geographic origin, and comparing these to historical data. The fraudulent return propensity score reflects the likelihood of coordinated fraudulent activities, such as temporary use of items followed by returns.

To calculate the fraudulent return propensity score, the system may employ various methods. One approach involves weighting multiple input parameters, such as the number of similar orders from a specific locality, the time taken to complete these orders, and any previous return episodes associated with the customers. Each parameter receives a weight based on the significance of the parameter in indicating potential fraud. The system then sums these weighted parameters to obtain a raw score. This score undergoes normalization to account for variations in order volume and customer behavior across different regions and time periods.

Thresholds for the fraudulent return propensity score can be set based on historical data analysis, considering factors such as typical order volumes, return rates, and geographic purchasing trends. For instance, a threshold may be established at a level where the score indicates a significant deviation from purchasing behavior, suggesting potential fraud. These thresholds can be adjusted dynamically, allowing the system to adapt to changing market conditions and consumer patterns. By setting appropriate thresholds, the system can effectively identify and mitigate fraudulent activities, preserving the integrity of return policies and reducing financial losses for retailers.

If the fraudulent return propensity score does not exceed the threshold, in one or more embodiments no action is taken at step 610. However, when the fraudulent return propensity score exceeds a predefined threshold, step 609 comprises precluding one or more additional user interaction events from occurring in each interactive session of the plurality of interactive sessions in the electronic shopping interactive computing environment.

In one or more embodiments, when the fraudulent return propensity score exceeds a first threshold above the predefined threshold, the precluding the one or more additional user interaction events in the each interactive session at step 609 comprises precluding all user interaction events from occurring in the each interactive session of the plurality of interactive sessions in the electronic shopping interactive computing environment. In one or more embodiments, when the fraudulent return propensity score exceeds a second threshold located between the predefined threshold and the first threshold, but fails to exceed the first threshold, the precluding the one or more additional user interaction events in the each interactive session at step 609 comprises precluding a shopping cart completion interaction event from occurring in the each interactive session of the plurality of interactive sessions in the electronic shopping interactive computing environment.

In one or more embodiments, when the fraudulent return propensity score exceeds a third threshold located between the predefined threshold and the second threshold, but fails to exceed the second threshold, the precluding the one or more additional user interaction events in the each interactive session at step 609 comprises presenting a prompt on a user interface of remote electronic devices engaged in the plurality of interactive sessions indicating that any shopping cart completion interaction events will be unavailable for product return user interaction events in the electronic shopping interactive computing environment.

Examples of prompts are described above with reference to FIGS. 7-9. In one or more embodiments, the prompt identifies whether the one or both of shopping cart user interaction events and/or product return user interaction events will be precluded from occurring in the electronic shopping application.

In one or more embodiments, the prompt is presented only when the one or more processors detect an amount of time used to place each order of the plurality of orders being less than an average amount of time used to place each historical order of the historical set of orders by a predefined amount. In one or more embodiments, the prompt is presented only when the one or more processors detect a delivery address of the each order of the plurality of orders is within a predefined distance of each other order of the plurality of orders. Step 609 can further comprise precluding any product return user interaction events corresponding to the plurality of interactive sessions in the electronic shopping interactive computing environment occurring after presentation of the prompt.

Decision 611 determines whether the customer still wishes to make the purchase after the preclusionary steps of 609 have been performed. If so, the order is fulfilled at step 612. Otherwise, no action is taken at step 610.

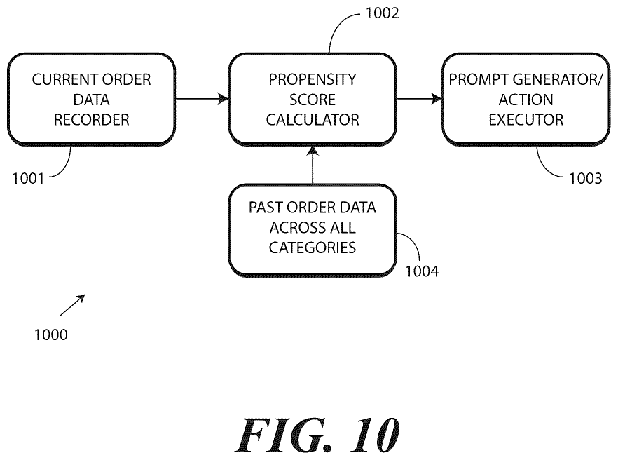

Turning now to FIG. 10, illustrated therein is one explanatory system 1000 in accordance with one or more embodiments of the disclosure. The system 1000 includes a current order data recorder 1001, a propensity score calculator 1002, a prompt generator/action executor, and a past order data store 1004.

The current order data recorder 1001 collates, using one or more processors, a plurality of orders of products having a common category and originating from a common geographic area. The propensity score calculator 1002 determines a fraudulent return propensity score by comparing the plurality of orders to a historical set of orders of other products having a plurality of categories received from the past order data store 1004. The prompt generator/action executor 1003 can present, by one or more processors on a user interface of remote electronic devices responsible for the plurality of orders, in response to the fraudulent return propensity score exceeding a predefined threshold, a prompt. The prompt generator/action executor 1003 can also preclude one or more additional user interaction events from occurring in each interactive session of the plurality of interactive sessions in the electronic shopping interactive computing environment, as noted above.

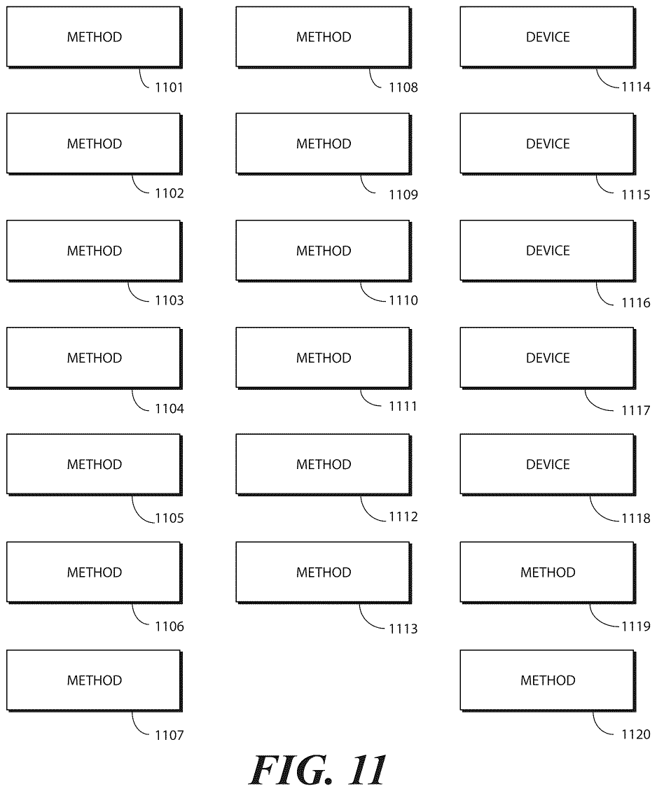

Turning now to FIG. 11, illustrated therein are various embodiments of the disclosure. The embodiments of FIG. 11 are shown as labeled boxes in FIG. 11 due to the fact that the individual components of these embodiments have been illustrated in detail in FIGS. 1-10, which precede FIG. 11. Accordingly, since these items have previously been illustrated and described, their repeated illustration is no longer essential for a proper understanding of these embodiments. Thus, the embodiments are shown as labeled boxes.

At 1101, a method in an electronic device comprises, in response to initiation of a plurality of interactive sessions in an electronic shopping interactive computing environment operating on one or more processors of the electronic device, determining, by the one or more processors, a fraudulent return propensity score as a function of a plurality of shopping cart interaction events occurring in the plurality of interactive sessions in the electronic shopping interactive computing environment. At 1101, when the fraudulent return propensity score exceeds a predefined threshold, the method comprises precluding one or more additional user interaction events from occurring in each interactive session of the plurality of interactive sessions in the electronic shopping interactive computing environment.

At 1102, when the fraudulent return propensity score exceeds a first threshold above the predefined threshold, the method of 1101 comprises precluding the one or more additional user interaction events in the each interactive session comprises precluding all user interaction events from occurring in the each interactive session of the plurality of interactive sessions in the electronic shopping interactive computing environment. At 1103, when the fraudulent return propensity score exceeds a second threshold located between the predefined threshold and the first threshold, but fails to exceed the first threshold, the precluding the one or more additional user interaction events in the each interactive session of 1102 comprises precluding a shopping cart completion interaction event from occurring in the each interactive session of the plurality of interactive sessions in the electronic shopping interactive computing environment.

At 1104, when the fraudulent return propensity score exceeds a third threshold located between the predefined threshold and the second threshold, but fails to exceed the second threshold, the precluding the one or more additional user interaction events in the each interactive session of 1103 comprises presenting a prompt on a user interface of remote electronic devices engaged in the plurality of interactive sessions indicating that any shopping cart completion interaction events will be unavailable for product return user interaction events in the electronic shopping interactive computing environment. At 1105, the method of 1104 further comprises precluding, by the one or more processors, any product return user interaction events corresponding to the plurality of interactive sessions in the electronic shopping interactive computing environment occurring after presentation of the prompt.

At 1106, the determining of 1101 of the fraudulent return propensity score comprises, by the one or more processors, weighting a plurality of input parameters to obtain a plurality of weighted input parameters and summing the plurality of weighted input factors to obtain a raw fraudulent return propensity score. At 1107, the function of the plurality of shopping cart interaction events of 1101 has as a first input a delivery address associated with each shopping cart interaction event of the plurality of shopping cart interaction events.

At 1108, the function of the plurality of shopping cart interaction events of 1107 has as a second input a location from which the each shopping cart interaction event of the plurality of shopping cart interaction events originated. At 1109, the function of the plurality of shopping cart interaction events of 1108 has as a third input an amount of time taken for the each shopping cart interaction event of the plurality of shopping cart interaction events to occur.

At 1101, the function of the plurality of shopping cart interaction events of 1109 has as a fourth input whether any remote electronic device engaged in the plurality of interactive sessions has caused a return user interaction event to occur within a predefined previous time period in the electronic shopping interactive computing environment. At 1111, the function of the plurality of shopping cart interaction events of 1109 has as a fourth input whether a product category is common to the each interactive session of the plurality of interactive sessions.

At 1112, an electronic device comprises a memory and one or more processors operable with the memory. At 1112, in response to the one or more processors detecting a plurality of shopping cart interaction events occurring in a plurality of interactive shopping sessions occurring in an electronic shopping application operating on the one or more processors, the one or more processors determine a fraudulent return propensity score as a function of a product category and a location area associated with each shopping cart interaction event being common across the each shopping cart interaction event of the plurality of shopping cart interaction events. At 1112, when the fraudulent return propensity score exceeds a predefined threshold, the one or more processors preclude one or both of the plurality of shopping cart user interaction events and/or a plurality of product return user interaction events corresponding to the plurality of shopping cart interaction events from occurring in the electronic shopping application.

At 1113, when the fraudulent return propensity score exceeds another predefined threshold located above the predefined threshold the one or more processors of 1112 terminate the plurality of interactive shopping sessions. At 1114, when the fraudulent return propensity score exceeds another predefined threshold located above the predefined threshold the one or more processors of 1112 block both the plurality of shopping cart user interaction events and the plurality of product return user interaction events from occurring in the electronic shopping application.

At 1115, when the fraudulent return propensity score falls between the predefined threshold and the another predefined threshold the one or more processors of 1114 block only the plurality of product return user interaction events from occurring in the electronic shopping application. At 1116, the one or more processors of 1115 further cause the user interface to present a prompt on remote electronic devices engaged in the plurality of interactive shopping sessions identifying which of the one or both of the plurality of shopping cart user interaction events and/or the plurality of product return user interaction events is precluded from occurring in the electronic shopping application.

At 1117, a method in an electronic device comprises operating, by one or more processors of the electronic device, an electronic shopping application. At 1117, the method comprises collating, by the one or more processors, a plurality of orders of products having a common category and originating from a common geographic area to determine a fraudulent return propensity score when the plurality of orders is compared to a historical set of orders of other products having a plurality of categories. At 1117, the method comprises presenting, by the one or more processors, on a user interface of remote electronic devices responsible for the plurality of orders, in response to the fraudulent return propensity score exceeding a predefined threshold, a prompt.

At 1118, the prompt of 1117 identifies whether the one or both of shopping cart user interaction events and/or product return user interaction events will be precluded from occurring in the electronic shopping application. At 1119, the prompt of 1118 is presented only when the one or more processors detect an amount of time used to place each order of the plurality of orders being less than an average amount of time used to place each historical order of the historical set of orders by a predefined amount. At 1120, the prompt of 1119 is presented only when the one or more processors detect a delivery address of the each order of the plurality of orders is within a predefined distance of each other order of the plurality of orders.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims.

For example, in various embodiments the electronic device described can be implemented with different configurations to enhance the adaptability and functionality of the device. The device comprises a memory and one or more processors that work together to detect shopping cart interaction events within an electronic shopping application.

In one embodiment, the device could be a smartphone with a touch-sensitive display, allowing users to interact seamlessly with the shopping application. The processors in this embodiment might include a combination of an application processor and auxiliary processors to handle complex computations efficiently.

In another embodiment, the device could be a tablet with a larger display, providing a more expansive interface for users to manage their shopping activities. The processors could be optimized for high-speed data processing to quickly determine a fraudulent return propensity score based on product categories and location data.

Additionally, the device could be integrated with advanced communication modules, such as 5G or Wi-Fi 6, to ensure rapid data exchange and real-time updates. The memory could vary in size, from a few gigabytes in a basic model to several terabytes in a high-end version, to accommodate extensive data storage and processing needs. These embodiments demonstrate the device's versatility in adapting to different user requirements and technological advancements while maintaining the fundamental functionality of preventing fraudulent returns.

Similarly, in various embodiments the system for determining a fraudulent return propensity score in an electronic shopping environment can be implemented with different configurations and operational methods. One embodiment involves using a smartphone with integrated GPS to capture precise location data, enhancing the accuracy of identifying localized purchasing patterns.

Another embodiment might utilize a tablet with a larger display, allowing for more detailed user interaction and data visualization. The processors in these devices could range from basic microprocessors to advanced multi-processing systems, depending on the complexity of the data analysis required.

The system could also incorporate machine learning algorithms to dynamically adjust the thresholds for fraudulent activity detection based on historical data and emerging patterns. Additionally, the user interface could be customized to provide real-time alerts and prompts, guiding users through the shopping process while ensuring compliance with return policies. These embodiments demonstrate the system's adaptability to various technological environments and user needs, ensuring robust fraud detection while maintaining a seamless shopping experience.

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method in an electronic device, the method comprising:
in response to initiation of a plurality of interactive sessions in an electronic shopping interactive computing environment operating on one or more processors of the electronic device, determining, by the one or more processors, a fraudulent return propensity score as a function of a plurality of shopping cart interaction events occurring in the plurality of interactive sessions in the electronic shopping interactive computing environment; and
when the fraudulent return propensity score exceeds a predefined threshold, precluding one or more additional user interaction events from occurring in each interactive session of the plurality of interactive sessions in the electronic shopping interactive computing environment.

2. The method of claim 1, wherein when the fraudulent return propensity score exceeds a first threshold above the predefined threshold, the precluding the one or more additional user interaction events in the each interactive session comprises precluding all user interaction events from occurring in the each interactive session of the plurality of interactive sessions in the electronic shopping interactive computing environment.

3. The method of claim 2, wherein when the fraudulent return propensity score exceeds a second threshold located between the predefined threshold and the first threshold, but fails to exceed the first threshold, the precluding the one or more additional user interaction events in the each interactive session comprises precluding a shopping cart completion interaction event from occurring in the each interactive session of the plurality of interactive sessions in the electronic shopping interactive computing environment.

4. The method of claim 3, wherein when the fraudulent return propensity score exceeds a third threshold located between the predefined threshold and the second threshold, but fails to exceed the second threshold, the precluding the one or more additional user interaction events in the each interactive session comprises presenting a prompt on a user interface of remote electronic devices engaged in the plurality of interactive sessions indicating that any shopping cart completion interaction events will be unavailable for product return user interaction events in the electronic shopping interactive computing environment.

5. The method of claim 4, further comprising precluding, by the one or more processors, any product return user interaction events corresponding to the plurality of interactive sessions in the electronic shopping interactive computing environment occurring after presentation of the prompt.

6. The method of claim 1, wherein the determining the fraudulent return propensity score comprises, by the one or more processors, weighting a plurality of input parameters to obtain a plurality of weighted input parameters and summing the plurality of weighted input parameters to obtain a raw fraudulent return propensity score.

7. The method of claim 1, wherein the function of the plurality of shopping cart interaction events has as a first input a delivery address associated with each shopping cart interaction event of the plurality of shopping cart interaction events.

8. The method of claim 7, wherein the function of the plurality of shopping cart interaction events has as a second input a location from which the each shopping cart interaction event of the plurality of shopping cart interaction events originated.

9. The method of claim 8, wherein the function of the plurality of shopping cart interaction events has as a third input an amount of time taken for the each shopping cart interaction event of the plurality of shopping cart interaction events to occur.

10. The method of claim 9, wherein the function of the plurality of shopping cart interaction events has as a fourth input whether any remote electronic device engaged in the plurality of interactive sessions has caused a return user interaction event to occur within a predefined previous time period in the electronic shopping interactive computing environment.

11. The method of claim 9, wherein the function of the plurality of shopping cart interaction events has as a fourth input whether a product category is common to the each interactive session of the plurality of interactive sessions.

12. An electronic device, comprising:
a memory; and
one or more processors operable with the memory;
wherein:
in response to the one or more processors detecting a plurality of shopping cart interaction events occurring in a plurality of interactive shopping sessions occurring in an electronic shopping application operating on the one or more processors, the one or more processors determine a fraudulent return propensity score as a function of a product category and a location area associated with each shopping cart interaction event being common across the each shopping cart interaction event of the plurality of shopping cart interaction events; and
when the fraudulent return propensity score exceeds a predefined threshold, the one or more processors preclude one or both of the plurality of shopping cart interaction events and/or a plurality of product return user interaction events corresponding to the plurality of shopping cart interaction events from occurring in the electronic shopping application.

13. The electronic device of claim 12, wherein when the fraudulent return propensity score exceeds another predefined threshold located above the predefined threshold the one or more processors terminate the plurality of interactive shopping sessions.

14. The electronic device of claim 12, wherein when the fraudulent return propensity score exceeds another predefined threshold located above the predefined threshold the one or more processors block both the plurality of shopping cart interaction events and the plurality of product return user interaction events from occurring in the electronic shopping application.

15. The electronic device of claim 14, wherein when the fraudulent return propensity score falls between the predefined threshold and the another predefined threshold the one or more processors block only the plurality of product return user interaction events from occurring in the electronic shopping application.

16. The electronic device of claim 15, wherein the one or more processors further cause a user interface to present a prompt on remote electronic devices engaged in the plurality of interactive shopping sessions identifying which of the one or both of the plurality of shopping cart interaction events and/or the plurality of product return user interaction events is precluded from occurring in the electronic shopping application.

17. A method in an electronic device, the method comprising:
operating, by one or more processors of the electronic device, an electronic shopping application;
collating, by the one or more processors, a plurality of orders of products having a common category and originating from a common geographic area to determine a fraudulent return propensity score when the plurality of orders is compared to a historical set of orders of other products having a plurality of categories; and
presenting, by the one or more processors, on a user interface of remote electronic devices responsible for the plurality of orders, in response to the fraudulent return propensity score exceeding a predefined threshold, a prompt.

18. The method of claim 17, wherein the prompt identifies whether the one or both of shopping cart user interaction events and/or product return user interaction events will be precluded from occurring in the electronic shopping application.

19. The method of claim 18, wherein the prompt is presented only when the one or more processors detect an amount of time used to place each order of the plurality of orders being less than an average amount of time used to place each historical order of the historical set of orders by a predefined amount.

20. The method of claim 19, wherein the prompt is presented only when the one or more processors detect a delivery address of the each order of the plurality of orders is within a predefined distance of each other order of the plurality of orders.
